(19) United States
(12) Patent Application Publication
(10) Pub. No.: US 2017/0350421 A1
(43) Pub. Date: Dec. 7, 2017

(54) MANIFOLD FOR A DIRECTIONAL CONTROL VALVE FOR A VALVE ACTUATOR

(71) Applicant: Cowan Dynamics Inc., Montreal (CA)

(72) Inventor: Daniel Gagné, Montréal (CA)

(73) Assignee: Cowan Dynamics Inc., Montreal (CA)

(21) Appl. No.: 15/615,101

(22) Filed: Jun. 6, 2017

Related U.S. Application Data
(60) Provisional application No. 62/345,955, filed on Jun. 6, 2016.

(30) Foreign Application Priority Data
Mar. 21, 2017 (CA) 2961795

(51) Int. Cl. F15B 11/076; F16K 31/12

(52) U.S. Cl. CPC F15B 11/076; F16K 31/12; F15B 2211/212; F15B 2211/30555; F15B 2211/625; F15B 2211/4053

(57) ABSTRACT

A valve actuator control system, and a related manifold. The control system includes a pneumatic directional valve operable to move the actuator. The manifold has multiple internal channels and is mountable to the pneumatic directional valve in alternative connections so that one internal channel of the manifold is active and the others are non-active, so that the manifold and pneumatic directional valve can provide operability of the actuator in a plurality of different fail modes.

### FIELD

The present subject-matter relates to pneumatic and hydraulic control systems for valve actuators of the type used in many industrial processes.

### INTRODUCTION

The flow of fluids and other substances carried in process transport pipes is typically controlled using a process valve. It may be necessary in an industrial process to close, to open, to lock, or to keep open the process valve, in response to specific conditions of the flow and the environment, such as a detected change in the flow rate inside the pipe, temperature inside and/or outside of the pipe, flow pressure, outside environment pressure, etc.

Conventional control systems for valve actuators are generally designed to respond to changes in the process flow in one of four modes: fail open, fail close, fail last, and fail last locked. The process valve is typically configured in one of the four modes with tubes leading to the actuator, forming a tube network. Such tube networks of the control systems have to be quite circuitous with multiple fittings and bends to include components such as filter regulators, speed controllers, and so forth. The tube networks also need to be customized for each of the four configurations and therefore demand qualified labor during the installation and maintenance.

### SUMMARY

The following summary is intended to introduce the reader to the more detailed description that follows, and not to define or limit the claimed subject matter,

According to a first aspect, the present subject matter provides a valve actuator control system. The control system includes a pneumatic directional valve operable to move the actuator, and also a manifold having multiple internal channels, each channel having a manifold inlet port and a manifold outlet port.

The pneumatic directional valve has a valve inlet port and a valve outlet port The manifold is mountable directly to the pneumatic directional valve and is fluidly connectible to it in alternative connections such that the manifold outlet port and manifold inlet port of one active internal channel communicate with the valve inlet port and valve outlet port, respectively, of the pneumatic directional valve, while the other, non-active internal channels are isolated from the pneumatic directional valve.

The control system also includes closures that block the manifold outlet port and manifold inlet port of the non-active internal channels.

The multiple internal channels of the manifold are configured to provide operability of the actuator control system in at least a plurality of fail modes.

In some examples, the multiple internal channels of the manifold are configured to provide operability of the actuator control system in any one of fail-open, fail-close, or fail-last modes.

In some examples, the multiple internal channels of the manifold are configured to provide operability of the actuator control system in any one of fail-open, fail-close, fail-last, or fail-last-locked modes.

According to another aspect, the present subject matter provides a pneumatic manifold for a directional valve that operates to move the actuator of a valve actuator control system. The manifold is connectable to the directional valve and comprises a unitary body having multiple internal channels, each with a manifold inlet port and a manifold outlet port. The manifold is connectable to the directional valve in alternative connections such that the manifold outlet port and manifold inlet port of one active internal channel communicate with the valve inlet port and valve outlet port, respectively, of the pneumatic directional valve. The multiple internal channels of the manifold are configured to provide operability of the actuator control system in at least a plurality of fail modes.

In some examples, the multiple internal channels of the manifold are configured to provide operability of the actuator control system in any of fail-open, fail-close, or fail-last modes.

In some examples, the multiple internal channels of the manifold are configured to provide operability of the actuator control system in any of fail-open, fail-close, fail-last or fail-last-locked modes.

According to another aspect, the present subject matter provides a manifold block for a directional valve that controls the actuator of a process valve. The manifold block is connectable to the directional valve and comprises a plurality of manifold valve ports that are adapted to receive a plurality of complementary ports of the directional valve. A plurality of manifold channels is located inside the manifold block, each of the manifold channels extending between at least two manifold ports being adapted to conduct pressurized air between them. The manifold block is configured to operatively connect the directional valve to a pressurized air supply in at least one of fail-open, fail-close, fail-last and fail-last-locked operating modes.

In some examples, the manifold block is configured so that the directional valve is adapted to control the actuator in at least one operating mode chosen from fail-open, fail-close, fail-last, and fail-last-locked.

In some examples, the directional valve is controlled by at least one pilot solenoid valve which is connected to at least two of the input and output manifold ports.

In some examples, the manifold block is a unitary body.

### DRAWINGS

For a better understanding of the subject matter herein and to show more clearly how it may be carried into effect, reference will now be made, by way of example, to the accompanying drawings which show at least one exemplary embodiment, and in which:

FIG. 1 illustrates a schematic side view of a conventional control system for a process valve.

FIG. 2 illustrates a schematic side view of a conventional control system for a process valve.

FIG. 3A shows a schematic representation of an example of a conventional two-position solenoid directional valve for a fail-open configuration.

FIG. 36 shows a schematic representation of an example of a conventional two-position solenoid-operated directional valve for a fail-closed configuration.

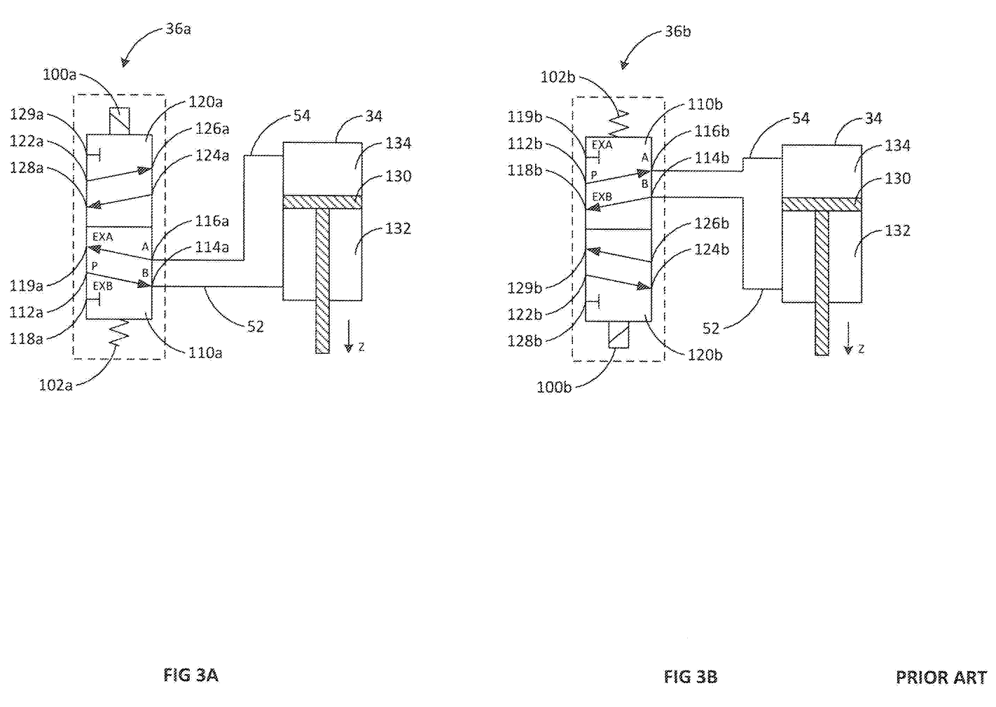

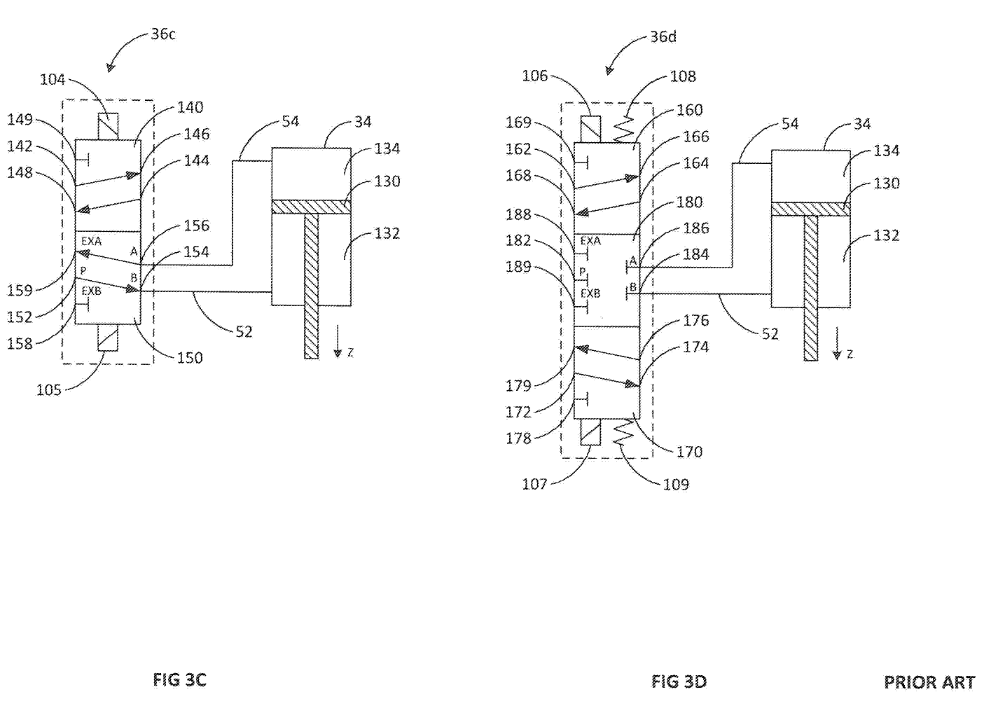

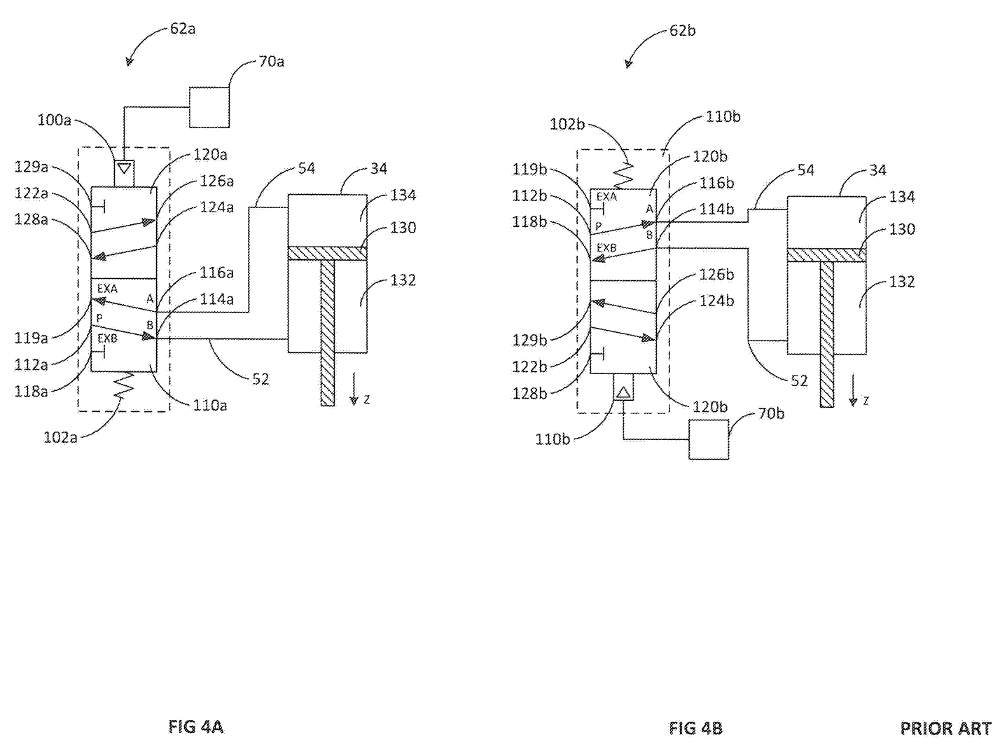

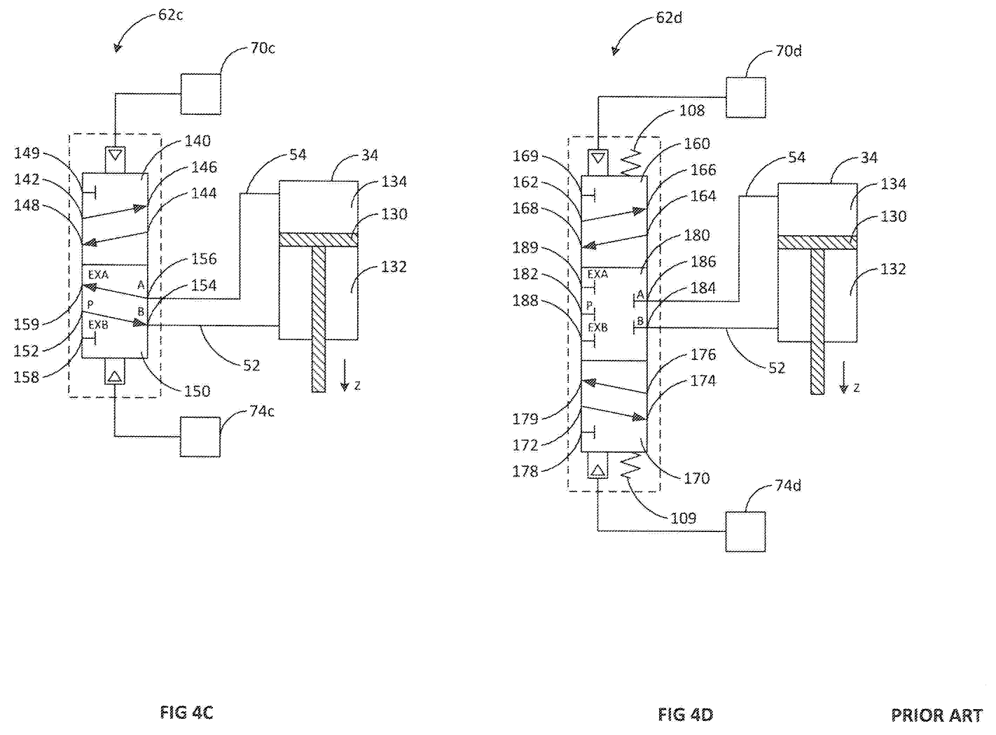

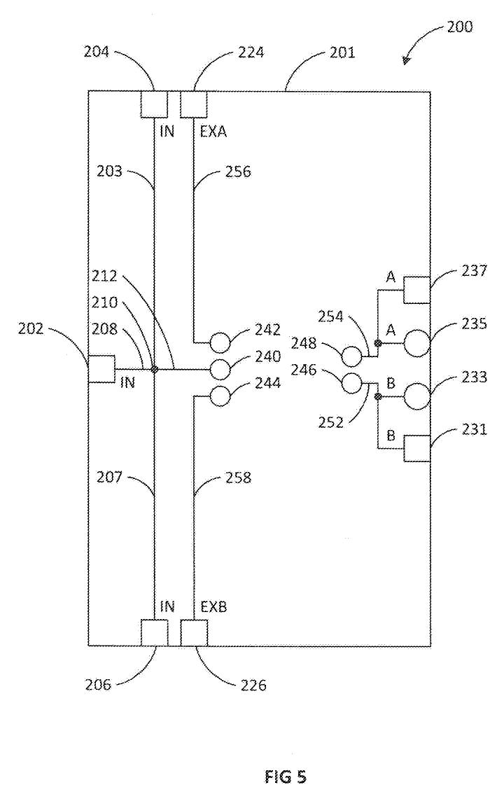

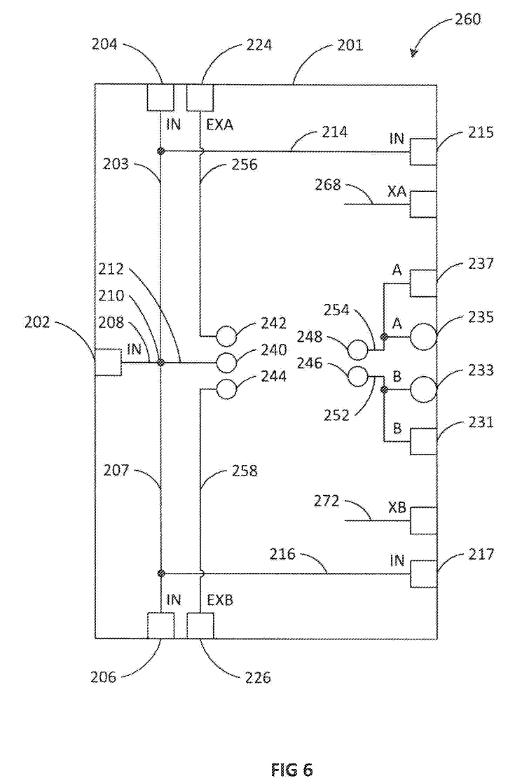

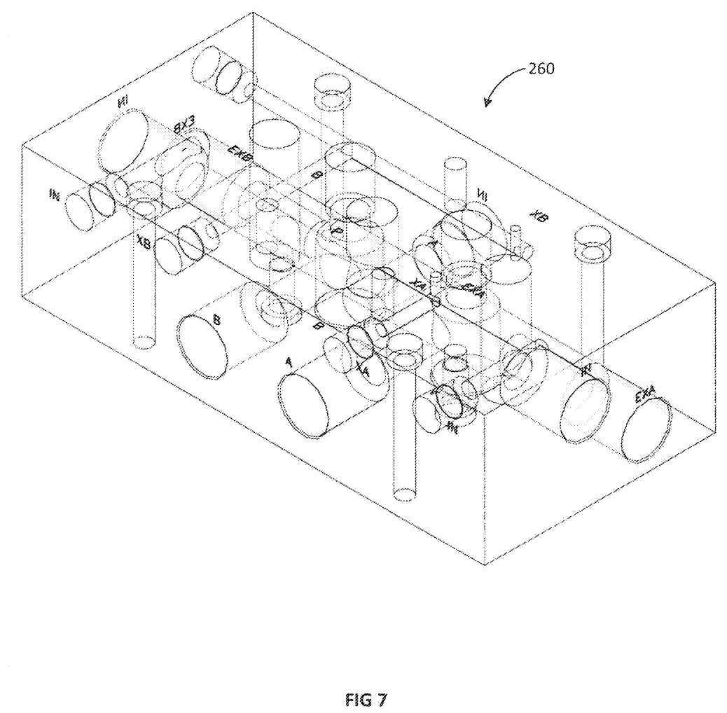

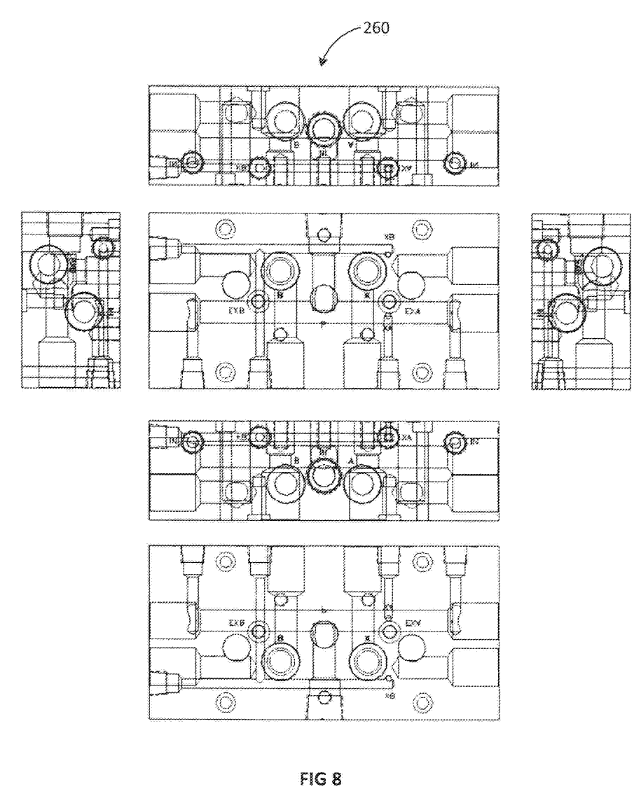

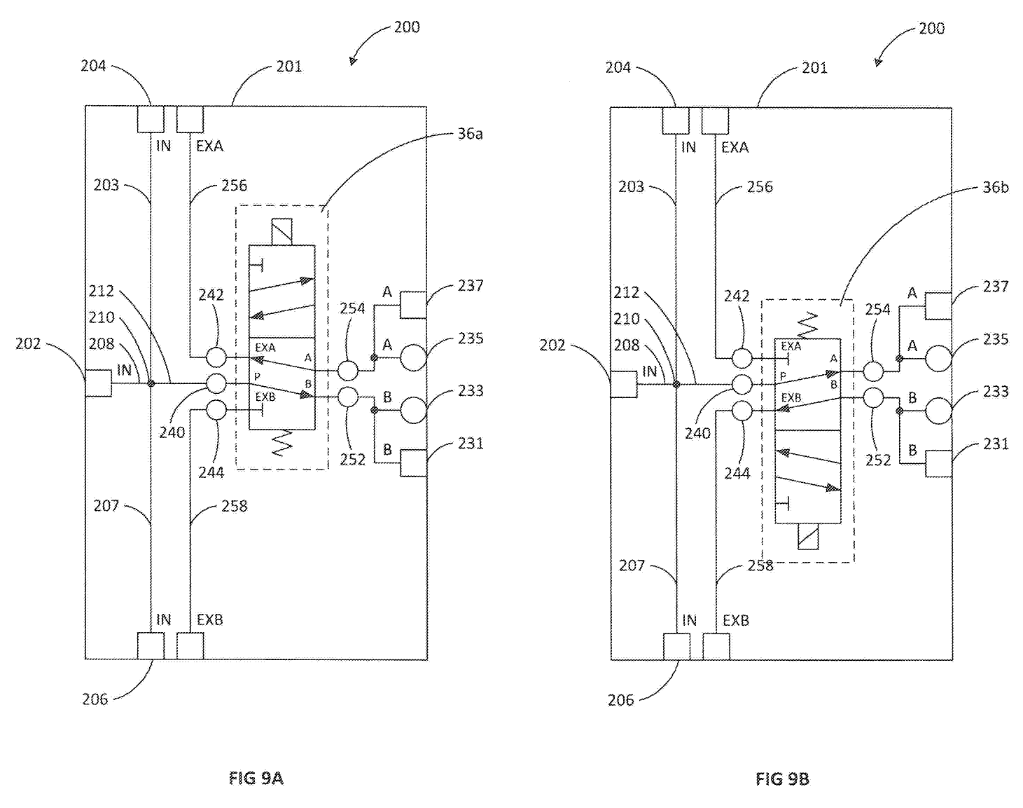

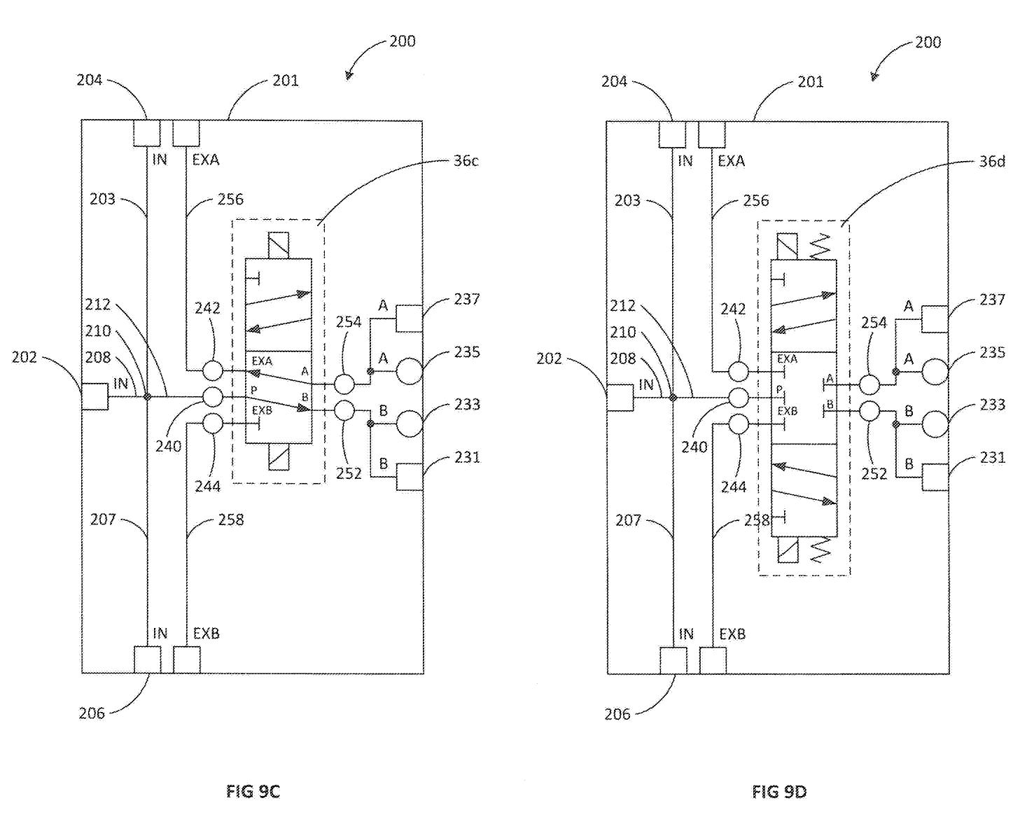

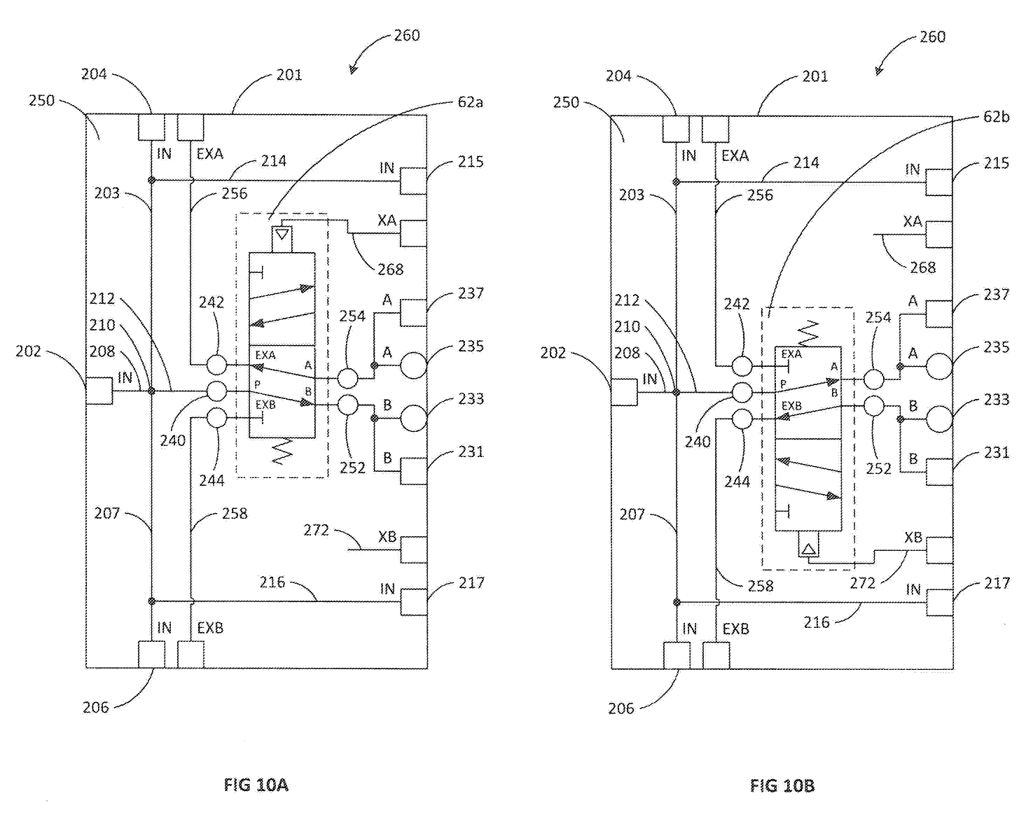

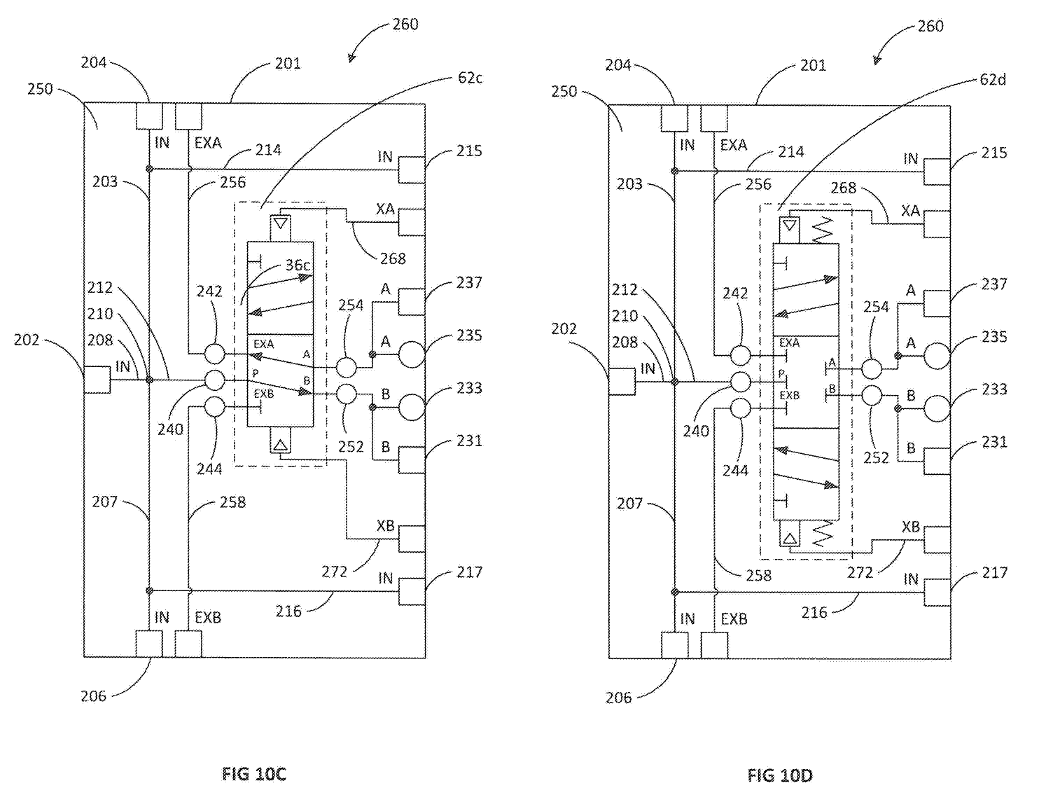

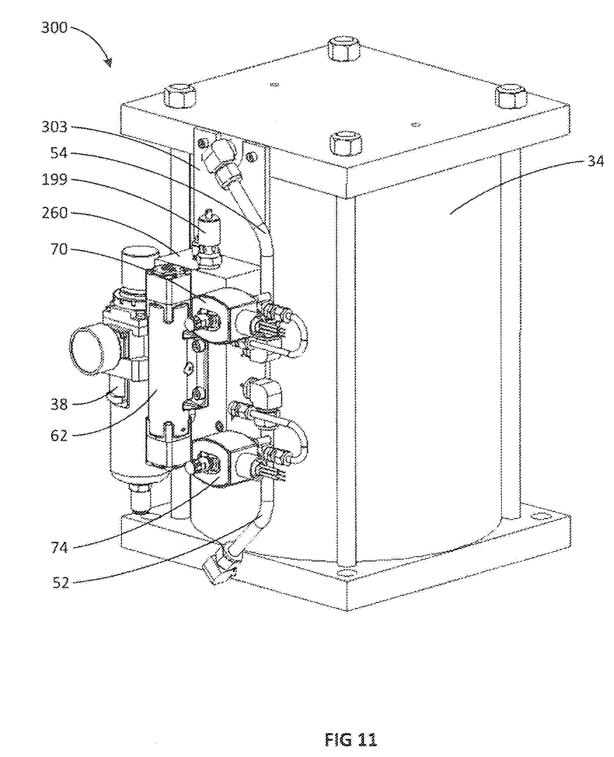

FIG. 3C shows a schematic representation of an example of a conventional two-position solenoid directional valve for a fail-last configuration.

FIG. 3D shows a schematic representation of an example of a conventional three-position solenoid directional valve for a fail-last-locked configuration.

FIG. 4A shows a schematic representation of a conventional piloted two-position directional valve for a fail-open configuration.

FIG. 46 shows a schematic representation of a conventional piloted two-position directional valve for a fail-closed configuration.

FIG. 4C shows a schematic representation of a conventional piloted two-position directional valve for a fail-last configuration.

FIG, 4D shows a schematic representation of a conventional piloted three-position directional valve for a fail-last-locked configuration.

FIG. 5 shows a schematic representation of a manifold block for control of an actuator, in accordance with at least one embodiment.

FIG. 6 shows a schematic representation of a manifold block adapted for the piloted directional valve, in accordance with at least one embodiment.

FIG. 7 shows a schematic perspective view of the manifold block, in accordance with at least one embodiment.

FIG. 8 shows a top view, a bottom view, and side views of an example embodiment of the manifold.

FIG. 9A shows a schematic representation of the manifold with the fail-open solenoid directional valve, in accordance with at least one embodiment.

FIG. 9B shows a schematic representation of the manifold with the fail-closed solenoid directional valve, in accordance with at least one embodiment.

FIG. 9C shows a schematic representation of the manifold with the fail-last solenoid directional valve, in accordance with at least one embodiment.

FIG. 9D shows a schematic representation of the manifold with the fail-last-locked solenoid directional valve, in accordance with at least one embodiment.

FIG. 10A shows a schematic representation of the manifold with the fail-open piloted directional valve, in accordance with at least one embodiment.

FIG. 10B shows a schematic representation of the manifold with the fail-closed piloted directional valve, in accordance with at least one embodiment.

FIG. 10C shows a schematic representation of the manifold with the fail-last piloted directional valve, in accordance with at least, one embodiment.

FIG. 10D shows a schematic representation of the manifold with the fail-last-locked piloted directional valve, in accordance with at least one embodiment.

FIG. 11 shows a perspective view of an actuator with a pneumatic manifold control system for the actuator.

### DESCRIPTION OF VARIOUS EMBODIMENTS

In the following description, specific details are set out to provide examples of the claimed subject matter. However, the embodiments described below are not intended to define or limit the claimed subject matter.

It will be appreciated that, for simplicity and clarity of illustration, where considered appropriate, reference numerals may be repeated among the figures to indicate corresponding or analogous elements or steps. Numerous specific details are set forth in order to provide a thorough understanding of the exemplary embodiments of the subject matter described herein. However, it will be understood by those of ordinary skill in the art that the embodiments described herein may be practiced without these specific details. In other instances, well-known methods, procedures and components have not been described in detail so as not to obscure the present subject matter. Furthermore, this description is not to be considered as limiting the scope of the subject matter in any way but rather as illustrating the various embodiments.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

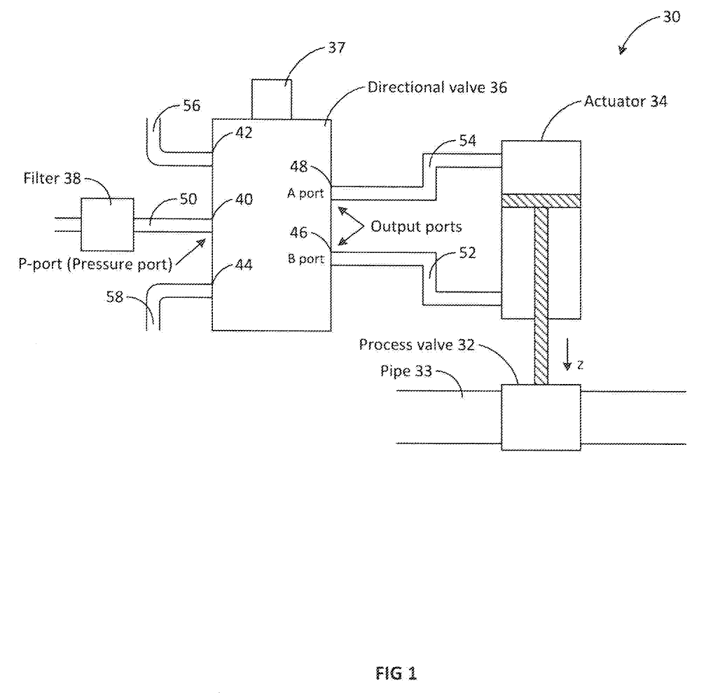

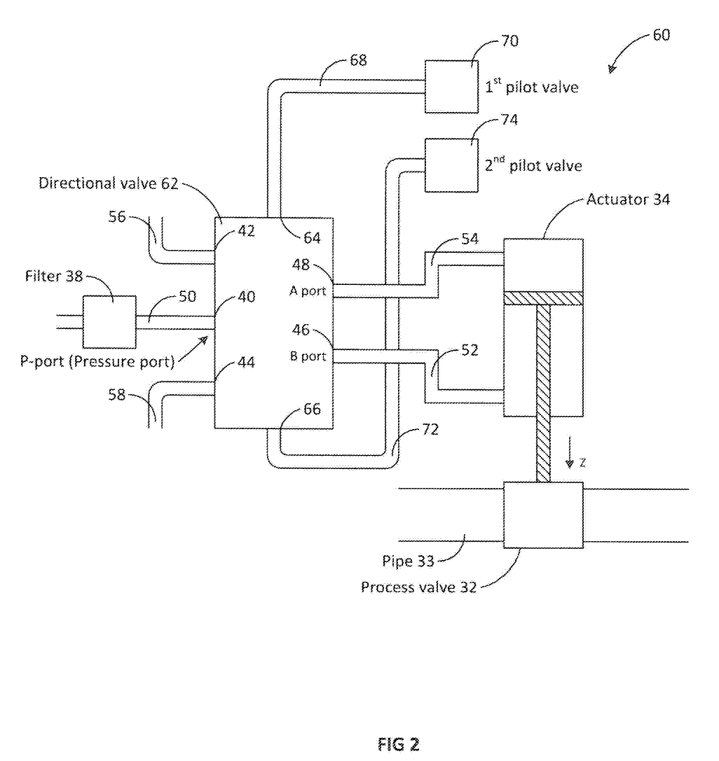

Examples of conventional control systems 30 and 60 for a process valve 32 actuated by actuator 34 are shown schematically at FIG. 1 and FIG. 2. A conventional control system 30 (or 60) comprises a directional valve 36 (or 62), a filter (filter-regulator) 38, and a plurality of tubes leading to ports of the directional valve 36 (or 62). Shown at FIG. 1 and FIG. 2 are five-port directional valves 36 and 62 with ports 40, 42, 44, 46, and 48.

It should be noted that the control system 30 may be pneumatic or hydraulic. Although pneumatic operation using air is described herein, the same operation and schematics can be used in a hydraulic control system 30, by replacing air with oil.

Depending on the type of the actuator 34 to be controlled and other requirements for the control system for the actuator 34, either a solenoid-operated directional valve 36 or a piloted directional valve 62 can be used in the control system for the actuator 34.

FIG. 1 illustrates a schematic side view of a conventional pneumatic control system 30 for the process valve 32 using a five-port solenoid-operated directional valve 36. The solenoid-operated directional valve 36 may be operated using at least one solenoid 37. As shown at FIG. 1, a plurality of tubes 50, 52, 54, 56, and 58 form a network of tubes which connects the directional valve 36 to the actuator 34, an input air filter 38, and exhaust controls (not shown). The solenoid 37 of the solenoid-operated directional valve 36 is electrically connected to the installation site's control system. Failure of this source (power failure, initiated emergency-stop of process shutdown) deactivates solenoid valve 37 which reverts to a known (‘fail’) position. A five-port directional valve 36 typically has a pressure port (P-port) 40, a first exhaust valve port 42, a second exhaust valve port 44, as well as two output ports: A-port 48 and B-port 46. The P-port 40 is an input port and is operatively connected to an input tube 50 which brings air from the filter 38. The output ports A-port 48 and t3-port 46, are connected to the actuator 34 through the A-tube 54 and B-tube 52. The first and the second exhaust valve ports 42, 44 are connected to exhaust tubes 56, 58, respectively, which may be connected, for example, to an exhaust flow control device (not shown at FIG. 1).

FIG. 2 illustrates a schematic side view of a conventional pneumatic control system 60 for the process valve 32 using, a five-port piloted directional valve 62. In addition to previously discussed P-port 40, A-port 46, B-port 48, and the first and the second exhaust valve ports 42, 44, the piloted directional valve 62 has at least one pilot port. At least one pilot solenoid valve can operate the piloted directional valve 62 through at least one pilot port.

Shown at FIG. 2 is the piloted directional valve 62 with a first pilot port 64 and a second pilot port 66. The first pilot port 64 may be operatively connected through a first pilot tube 68 to a first pilot solenoid valve 70. The second pilot port 66 may be operatively connected through a second pilot tube 72 to a second pilot solenoid valve 74. The first or the second solenoid pilot valves 70, 74 can operate the five-port piloted directional valve 62 using air pushed through the first or the second pilot tubes 68 and 72 to the first or the second pilot ports 64, 66. When the signal to the pilot solenoid valve fails, the corresponding pilot valve, 70 or 74 stops pushing air to the corresponding pilot port 64, 66 of the piloted directional valve 62.

Typically, a control system 30 for the actuator 34 of process valve 32 can operate in one of four configurations: fail-open, fail-close, fail-last, and fail-last-locked.

Each of the four configurations demands a specifically configured directional valve 36 or 62. FIGS. 3A, 3B, 3C, and 3D show conventional five-port solenoid directional valves 36a, 36b, 36c, and 36d, each operating in one of the four configurations.

FIGS. 3A, 3B, 3C, and 3D also schematically show an actuator 34 having a moving piston & piston rod 130 which separates the actuator's cylinder in two portions: a rod portion 132 and a cap portion 134. The A-port of any one of the solenoid directional valves 36a, 36b, 36c, and 36d may be connected via the tube 54 to the cap portion 134 of the actuator 34, while the B-port of any one of the solenoid directional valves 36a, 36b, 36c, and 36d may be connected via the tube 52 to the rod portion 132 of the actuator 34.

The five-port directional valve 36 (or 62) may be a five-port three-position directional valve or a five-port two-position directional valve, depending on the configuration it is used for.

### Fail-open

In a fail-open configuration, the process valve 32 needs to open when there is a failure of the solenoid valve's electrical signal

FIG. 3A shows a schematic representation of an example of a conventional two-position solenoid directional valve 36a for fail-open configuration (”FO solenoid directional valve“) connected to the actuator 34 through the tubes 52 and 54. Such a FO solenoid directional valve 36a can be operated by a solenoid 100a and a spring 102a.

The FO solenoid directional valve 36a may be in a rest position 110a (or home position, or default position), or in an activated position 120a. The A-port (represented schematically at FIG. 3A as port 116a in the rest position 110a and as port 126a in the activated position 120a) of the FO solenoid directional valve 36a is connected to the cap portion 134 of the actuator 34, while the B-port (represented schematically as 114a and 124a at FIG. 3A) of the FO solenoid directional valve 36a is connected to the rod portion 132 of the actuator 34.

When the FO solenoid valve 36a is in its rest position 110a, the air, received from the filter 38 to the P-port 112a, passes from the P-port 112a to the B-port 114a. From the B-port 114a, the air passes via the tube 52 to the rod portion 132 of the actuator 34, pushing, the piston & piston rod 130 and expanding the rod portion 132. The air from the cap portion 134 of the actuator 34 returns through the tube 54 to the A-port 116a and passes through the directional valve 36a to the exhaust port 119a.

When the solenoid 100a is activated, the FO solenoid valve 36a is in the activated position 120a. In this activated position 120a, the air passes from the P-port 122a to the A-port 126a, the cap portion 134 of the actuator 34 is therefore filled with air, and the process valve 32 is closed.

When the solenoid 100a is deactivated the FO solenoid valve 36a is returned to the rest position 110a by means of the spring 102a. In the rest position 110a, the air is brought from P-port 112a to B-port 114a and returns from the A-port 116a to the exhaust valve port 119a. In this rest position 110a, the air pushed from the B-port 114a via the tube 52 fills the rod portion 132 of the actuator 34 and the piston & piston rod 130 retracts in the−z direction and opens the process valve 32. The air from the cap portion 134 exhausts through the tube 54 via the port 116a and then through the port 119a.

### Fail-Closed

In a fail-closed configuration, the process valve 32 needs to close if there is a failure of the solenoid valve's electrical signal

Shown at FIG. 3B is a schematic representation of a two-position solenoid-operated directional valve 36b for fail-closed (”FC”) configuration (“FC solenoid directional valve”), connected to the actuator 34 through the tubes 52 and 54. The B-port (represented schematically as 114b and 124b at FIG. 3B) of the directional valve 36b is connected to the rod portion 132 of the actuator 34, while the A-port (represented schematically as 116b and 126b at FIG. 3B) is connected to the cap portion 134 of the actuator 34. Such a directional valve 36b can be in a rest position 110b or in an activated position 120b.

The FC solenoid directional valve 36b has a solenoid 100b for activation and a spring 102b. The FC solenoid directional valve 36b is in the activated position 120b when it is activated by the solenoid 100b and the air passes from the P-port 122b to the B-port 124b. The B-port 124b is connected to the rod portion 132 of the actuator 34, the rod portion 132 is filled with air, the rod is retracted in the−z direction and the process valve 32 is opened.

When there is no signal coming from the solenoid 100b, for example, when the industrial process has failed, the spring 102b moves the directional valve 36b to the rest position 110b. In the rest position 110b, the air passes from the P-port 112b to the A-port 116b and fills the cap portion 134 of the actuator 34 with air, thereby closing the process valve 32. The air from the rod portion 132 of the actuator then returns via the tube 52 to the port 114b and then exhausts through the port 118b.

### Fail-Last

Shown at FIG. 3C is an example of a two-position solenoid directional valve for the fail-last configuration (“FL solenoid directional valve”) 36c. The. FL solenoid directional valve 36c is activated by a first solenoid 104 or the second solenoid 105, and does not have springs, The FL solenoid directional valve 36c can be in a first position 140 or in a second position 150.

The B-port (represented schematically as 144 and 154 at FIG. 3C) of the directional valve 36c is connected to the rod portion 132 of the actuator 34, while the A-port (represented schematically as 146 and 156 at FIG. 3C) is connected to the cap portion 134 of the actuator 34.

The first solenoid 104 can move the FL solenoid directional valve 36c into a first position 140, where the air passes from the P-port 142 to the A-port 146, filling the cap portion 134 with air. As the cap portion 134 is filled with air, the process valve 32 is closed. When the solenoid 104 is deactivated, the directional valve 36c remains in the first position 140.

When the second solenoid 105 is activated, it can move the FL solenoid directional valve 36c into a second position 150, where the air passes from the P-port 152 to the B-port 154, filling the rod portion 132 of the actuator 34 with air. As the rod portion 132 is filled with air, the process valve 32 is opened. When the solenoid 105 is deactivated, the directional valve 36c remains in the second position 150.

### Fail-Last-Locked

FIG. 3D shows an example of a three-position solenoid directional valve for the fail-last-locked configuration (“FLL solenoid directional valve”) 36d. The FLL solenoid directional valve 36d has a first solenoid 106, a second solenoid 107, and a first spring 108 and a second spring 109. The FLL solenoid directional valve can be in a first position 160, a second position 170, or a third (middle) position 180.

When the first solenoid 106 is activated, the directional valve 36d is in the first position 160 and the air passes from the P-port 162 to the A-port 166. The cap portion 134 of the actuator 34 is filled with air and the process valve 32 is closed. The air from the rod portion 132 returns (exhausts) through the B-port 164 to the exhaust valve port 168.

When the first solenoid 106 is deactivated, the first and the second springs 108 and 109 move the FLL solenoid directional valve 36d into the third (middle) position 180. In the third position 180, the FLL solenoid directional valve 36d is closed and no air passes from the P-port 182 to either the A-port 186 or the B-port 184.

When the second solenoid 107 is activated, the directional valve 36d is in the second position 170 and the air passes from the P-port 172 to the B,-port 174. In this case, the rod portion 132 of the actuator 34 is filled with air and the process valve 32 is opened. The air from the cap portion 134 exhausts through the A-port 176 to the exhaust valve port 179.

When the second solenoid 107 is deactivated, the first and the second springs 108 and 109 move the FLL solenoid directional valve 36d into the third (middle) position 180, closing the FLL solenoid directional valve 36d such that no air passes from the P-port to either the A-port or the B-port.

Referring back to FIG. 2, the directional valve can be piloted by one or two pilot valves. The pilot valve or valves (70 and/or 74) can control the piloted directional valve 62 by means of the airflow. When the system fails, the pilot valve or valves stop sending air to the piloted directional valve 62, sending therefore a “failure” signal to the piloted directional valve 62, It should be noted that, typically, the solenoid directional valves 36 and the piloted directional valves 62 have different physical dimensions.

FIGS. 4A, 4B, 4C and 4D show piloted directional valves 62a, 62b, 62c, and 62d, each adapted to operate in one of four configurations: fail-open, fail-closed, fail-last or fail-last-locked.

FIG. 4A shows a piloted directional valve for a fail-open configuration (“FO piloted directional valve”) 62a. The FO piloted directional valve 62a operates in a similar manner to the FO solenoid directional valve 36a discussed above, except that the piloted valve 62a is activated by a pilot valve 70a. The pilot valve 70a controls the FO piloted directional valve 62a by the flow of the air.

When the pilot valve 70a pushes the air to the FO piloted directional valve 62a, the FO piloted directional valve 62a is in the activated position 120a. In the activated position 120a, the air received by the P-port 122a is transmitted to the A-port 126a, and then through the pipe 54 to the cap-portion 134 of the actuator 34, thereby closing the process valve 32.

On failure of pilot valve 70a, it stops sending/transmitting air to the piloted directional valve 62a. With the absence of air from the pilot valve 70a, the spring 102a moves the directional valve 62a into its rest position 110a. In this rest position 110a, the input air from the P-port 112a is transmitted to the B-port 114a, and then, via tube 52, to the rod portion 132 of the actuator 34, thereby forcing the piston & piston rod 130 to move in the−z direction, opening the process valve 32.

FIG. 4B shows a piloted directional valve for a fail-closed configuration (“FC piloted directional valve”) 62b, which operates in a similar manner as the FC solenoid directional valve 36b, with the exception that the piloted valve 62b is activated by a pilot valve 70b (instead of the solenoid 100b).

FIG. 4C shows a piloted directional valve for a fail-last configuration (“FL piloted directional valve”) 62c, which operates in a similar manner as the FL solenoid directional valve 36c, with the exception that the FL piloted directional valve 62c is activated by a first pilot valve 70c and a second pilot valve 74c (instead of the first and the second solenoids 104 and 105).

FIG. 4D shows a piloted directional valve for a fail-last-locked configuration (“FLL piloted directional valve”) 62d, which operates in a similar manner as the solenoid directional valve 36d, with the exception that the FLL piloted valve 62d is activated by the first pilot valve 70d or the second pilot valve 74d (instead of the first and the second solenoids 106 and 107).

Referring back to the conventional control systems 30 and 60 at FIGS. 1-2, the network of tubes 50, 52, 54, 56, and 58, leading from the directional valves 36 or 62 to the actuator 34 and to supporting components, should be designed, adapted and installed specifically for each control system. Interconnecting tubing is prone to leakage because of the numerous connection points, is subject to failure due to mechanical damage and/or vibrations, and is not well suited for compact assemblies.

### Manifold

Referring now to FIG. 5, shown therein is a schematic representation of an example embodiment of a manifold block 200 for control of an actuator 34. For example, the manifold 200 may be a parallelepiped. For example, the manifold may be a rectangular parallelepiped. Different materials can be used to build the manifold; steel, ductile iron, aluminum or stainless-steel.

The manifold 200 comprises a plurality of manifold ports and a plurality of manifold channels. Each manifold channel may have two or more ports and may permit the air to pass in the manifold channel from at least one port to at least another port of the same manifold channel. Each manifold port may permit the air to enter and exit one of the manifold channels at an external surface 201 of the manifold 200. The manifold ports may be located at different sides (facets) of the manifold 200.

In at least one embodiment, the manifold channels of the manifold 200 may shorten or even replace the conventional tube network of the control system 30 (or 60). In at least one embodiment, the filter 38, a pressure relief valve, as well as exhaust flow control devices (valve/muffler), and/or other devices, may be operatively connected directly to the manifold 200.

In at least one embodiment, the manifold 200 may be operatively coupled to the directional valves 36 or 62. In at least one embodiment, five ports of the manifold 200 (ports 240, 242, 244, 246, and 248) may be adapted to receive the ports of the solenoid directional valve 36. The ports of the manifold 200 may be complementary to the ports of the directional valves 36 or 62.

The solenoid directional valve 36 for any one of the four configurations fail-open (36a), fail-closed (36b), fail-last (36c) or fail-last-locked (36d) as discussed herein may be operatively connected (coupled) to the manifold 200. The filter 38, at least one exhaust flow control device, as well as a pressure relief valve may also be operatively coupled to the ports of the manifold 200.

Referring to FIG. 5, the manifold 200 comprises at least one air input channel 212, which may have at least one input port 202 and an output port 240. The output port 240 of the air input channel 212 may be operatively connected to the P-port 40 of the directional valve 36. The input port 202 may be operatively connected to the filter 38.

Shown at FIG. 5 is an example embodiment with the air input manifold channel 212 having three input manifold ports (a first input manifold port 202, a second input manifold port 204, and a third input manifold port 206) and three channel portions 207, 208, and 203, merged at a node 210 into the air input manifold channel 212. The air input manifold channel 212 then leads to the output port 240 of the air input manifold channel 212. For example, the air input manifold channel 212 may have further channel portions, each merged into the air input manifold channel 212 or into at least one of its portions.

In at least one embodiment, the second input port 204 may be operatively connected to the pressure relief valve. In at least one embodiment, one or more of input ports may be plugged. Multiples of the internal channels offers the possibility of interconnecting different peripheral devices (such as a pressure relief valve and/or piloting solenoid valves) and/or simplifying interconnections on different faces of the manifold to optimize compactness of the final assembly. All unused ports, with the exception of the exhaust ports 224 and 226, must be plugged with appropriate plugs.

The manifold 200 may further comprise a first exhaust manifold channel 256 and a second exhaust manifold channel 258. The first exhaust channel 256 may have two manifold exhaust ports 242 and 224, and the second exhaust channel 258 may also have two manifold exhaust manifold ports 244 and 226. In at least one embodiment, the first and the second exhaust manifold ports 258 and 244 may be adapted to receive the first and the second exhaust valve ports 58 and 44 of the directional valve 36, such that the manifold 200 may be operatively connected to the directional valve 36.

The exhaust manifold ports 224 and 226 may be adapted to receive the exhaust flow control mufflers. If no accessories are required for the exhaust function, these ports are to be left opened.

The manifold 200 may further comprise an A-channel 254 and a B-channel 252, each having at least two ports. A first manifold A-port port 248 of the A-channel 254 may be adapted to connect to the A-port 48 of the directional valve 36. At least one exit manifold B-port (for example, port 231 or port 233) of the B-channel may be operatively connected to the actuator 34, the unused port is thus appropriately plugged.

A first manifold B-port 246 of the B-channel 252 may be operatively connected to the B-port 46 of the directional valve 36. At least one exit manifold B-port (for example, port 231 or port 233) of the B-channel 252 may be operatively connected to the actuator 34, the unused port is thus appropriately plugged.

In at least one embodiment, at least one exit manifold A-port may have one form and/or dimension and/or standard, and the other exit manifold A-port may have another form and/or dimension and/or standard. Similarly, at least one exit manifold B-port may have one form and/or dimension and/or standard, and the other exit manifold B-port may have another form and/or dimension and/or standard. For example, the exit manifold ports 233 (and/or 235) may have the NAMUR standard, and exit manifold ports 231 (and/or 237) may have the National Pipe Thread (NPT) standard. Having two different ports may allow reducing the number of components, such as adapters, to be used in the control system. ‘NAMUR’ describes a mechanical interface pattern used to mate a directional valve onto a flat surface and is typically used in pneumatic rotary actuators. Other port types can also be integrated such as BSP and SAE.

For example, when one manifold A-port 237 is used, the other A-port 235 may be blocked/plugged with an appropriate port plug (plug appropriate for the type of port, NPT, BSP, SAE, NAMUR).

Shown at FIG. 6 is a schematic representation of another example embodiment of a manifold block 260 adapted for the piloted directional valve 62. In addition to the manifold channels and ports discussed herein in reference to the manifold block 200, the manifold block 260 may have at least two pilot manifold channels: a first pilot channel 268 and a second pilot channel 272, each having at least two ports. The first and the second pilot channels 268 and 272 are adapted to be operatively connected to the first and the second pilot valves 70 and 74, respectively. Channels 214 and 216 forward inlet air to ports 215 and 217 respectively which can be used by the externally connected pilot valves 70 and 74 as the air source to be directed toward pilots 64 and 66. This feature greatly enhances the compactness and reliability of the assembly by eliminating the requirement of external interconnections.

Shown at FIG. 7 is a schematic perspective view (three-dimensional view) of an example embodiment of the manifold 260. It should be noted that the manifold channels may be of any form. For example, the manifold channels may have similar or different cross-sections. For example, a cross-section of at least one manifold channel may have round, elliptical or a convex polygon form, The form and at least one dimension of the cross-section of at least one manifold channel may be constant over at least one portion of the at least one manifold channel and/or may vary along the length of the at least one manifold channel.

FIG. 8 shows a top view, a bottom view, and side views of an example embodiment of the manifold 260.

FIG. 9A shows a schematic representation of the manifold 200 with the FO solenoid directional valve 36a. FIG. 9B shows a schematic representation of the manifold 200 with the FC solenoid directional valve 36b. FIG. 9C shows a schematic representation of the manifold 200 with the FL solenoid directional valve 36c. FIG. 9D shows a schematic representation of the manifold 200 with the FLL solenoid directional valve 36d.

The same manifold 200 may be operatively connected to receive any of the directional solenoid valves 36a, 36b, 36c, or 36d, each adapted to a different configuration, such as fail-open, fail-close, fail-last, and fail-last-locked,

FIG. 10A shows a schematic representation of the manifold 260 with the FO solenoid directional valve 62a. FIG. 10B shows a schematic representation of the manifold 260 with the FC solenoid directional valve 62b. FIG. 10C shows a schematic representation of the manifold 260 with the FL solenoid directional valve 62c. FIG. 10D shows a schematic representation of the manifold 260 with the FLL solenoid directional valve 62d.

The solenoid directional valves 36 and the piloted directional valves 62 typically have different dimensions. Nevertheless, the manifold 260 may be adapted to receive a solenoid direction valve 36, all the unused ports of the manifold 260 are plugged with the exception of the exhaust ports.

FIG. 11 shows a perspective view of an actuator 34 with a pneumatic manifold control system for the actuator. Shown at FIG. 11 is an example embodiment of the manifold 260, operatively connected to the directional valve 62. Two pilot valves 70 and 74 are operatively connected to the manifold 260.

The pneumatic manifold control system for an actuator may comprise the directional valve 36 or 62, the pressure relief valve 199, the filter 38, and the manifold block 260. The manifold block 260 may connect using the manifold channels the filter 38, the pressure relief valve 199, and the directional valve 36 or 62, with each other and with the actuator 34.

As shown at FIG. 11, only two tubes 52 and 54 may lead from the manifold block 260 to the actuator 34. Comparing FIG. 11 to FIG. 2, the conventional control system 60 would need a larger number of tubes in order to connect the directional valve 36 to the control devices (such as the filter 38, the pressure relief valve 199, and the exhaust flow control device). The number of tubes in the control system 300 may be considerably reduced due to the manifold 260. The manifold channels as described herein replace the tubes of the conventional control system 60 (or 30).

The directional valve may be the solenoid directional valve 36 or the piloted directional valve 62, piloted by at least one pilot solenoid valve 70 (and/or 74). The pilot solenoid valves 70 and/or 74, as shown at FIG. 11, may be connected directly to the manifold 260, i.e. to the manifold channels 268 and/or 272.

As described herein, the pneumatic manifold control system for a valve actuator may operate in at least one of the control configurations. The control configuration of the pneumatic manifold control system may be one of fail-open, fail-close, fail-last, and fail-last-locked configurations and is dependent of the directional valve used in the system.

The manifold 260 may be attached to the plate 303, while the plate 303 may be attached to the actuator 34.

Different manifold blocks may be provided, each with the functionality indicated herein, to suit different size directional valves: a ¼ size manifold block to suit the ¼ size solenoid operated directional valve 36; a ½ size to suit the ½ size piloted directional valve 62; and a size 1 to suit a 1 size piloted directional valve also depicted by 62. The physical sizes of these blocks are: ¼ size−4 in long×4 in wide×1.5 in high; ½ size−8 in long×4 in wide×2.25 in high; and 1 size−10 in long×4.25 in wide×3.5 in high.

The manifold based control system offers numerous advantages over the existing methods used in the industry: increased reliability, compactness and cost effectiveness of the final assembly by eliminating the majority of external component interconnections, optimized modularity permits four different control schemes by changing a single component (FO, FC, FL, FLL), and simplifies the addition of numerous accessories, easy physical installation since the block is used as a mounting platform for all accessories, cost effective manufacturing of the block since it can be mass produced, numerous port options, configurations and physical installation possibilities permit its use in a wide scope of applications.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A manifold block connectable to a directional valve that controls the actuator of a process valve, the manifold block comprising:
a) a plurality of manifold valve ports, adapted to receive a plurality of complimentary ports of the directional valve;
b) a plurality of manifold channels located inside the manifold block, each of the manifold channels extending between at least two manifold ports and being adapted to conduct pressurized air between them;
wherein the manifold block is configured to operatively connect the directional valve to a pressurized air supply in at least one of fail-open, fail-close, fail-last, and fail-last-locked operating modes.

2. The manifold block of claim 1, wherein the manifold block is configured so that the directional valve is adapted to control the actuator in at least one operating mode chosen from fail-open, fail-close, fail-last, and fail-last-locked.

3. The manifold block of claim 2, wherein the directional valve is controlled by at least one pilot solenoid valve, the at least one pilot solenoid valve being connected to at least two input and output manifold ports.

4. The manifold block of claim 3, wherein the manifold block is a unitary body.

5. The manifold block of claim 1, wherein the plurality of manifold channels each comprises:
a) an input channel, having at least one manifold port adapted to couple to a pressure port of the directional valve;
b) a first actuator control channel, having; at least two ports to connect an A-port of the directional valve to the actuator;
c) a second actuator control channel, having at least two ports to connect a B-port of the directional valve to the actuator; and
d) two exhaust channels, each having at least two ports;
and wherein the manifold block is configured to operatively connect the directional valve to control devices and to the actuator.

6. The manifold block of claim 5, further comprising a first pilot channel located inside the manifold block, the first pilot channel having two ports and being adapted to receive air from a first pilot valve and to transmit the air to the directional valve.

7. The manifold block of claim 6, further comprising a second pilot channel located inside the manifold block, the second pilot channel having two ports and being adapted to receive air from a second pilot valve and to transmit the air to the directional valve.

8. The manifold block of claim 5, wherein the manifold block is configured to control the actuator valve in at least one control configuration chosen from fail-open, fail-close, fail-last, and fail-last-locked.

9. The manifold block of claim 5, wherein at least one port may be blocked to achieve at least one control configuration.

10. A control system for an actuator of a process valve, the system comprising:
a) a directional valve adapted to control the actuator;
b) a pressure relief valve;
c) a filter; and
d) a manifold block having a plurality of internal channels each with a manifold inlet port and a manifold outlet port, the manifold block connecting with the manifold channels the filter, the pressure relief valve, and the directional valve, with each other and with the actuator.

11. The control system of claim 10, wherein two manifold channels of the plurality of manifold channels are connected to the actuator.

12. The control system of claim 10, wherein the directional valve is piloted by at least one solenoid valve that is connected to the directional valve through at least one pilot manifold channel.

13. The control system of claim 10, wherein the pneumatic manifold control system for a valve actuator may operate in at least one of the control modes chosen from fail-open, fail-close, fail-last, and fail-last-locked.

14. The control system of claim 10, comprising:
a pneumatic directional valve operable to move the actuator, the pneumatic directional valve having a valve inlet port and a valve outlet port; and wherein
the plurality of internal channels of the manifold is configured to provide operability of the actuator control system in at least a plurality of fail modes; and
the manifold is mountable to the pneumatic directional valve and fluidly connectable to it in alternative connections such that the manifold outlet port and manifold inlet port of one active internal channel communicate with the valve inlet port and valve outlet port, respectively, of the pneumatic directional valve, while the other, one or more non-active internal channels are isolated from the pneumatic directional valve; and
further comprising closures that block the manifold outlet port and manifold inlet port of the one or more non-active internal channels;

15. The control system of claim 14, wherein the multiple internal channels of the manifold are configured to provide operability of the actuator control system in any of fail-open, fail-close, or fail-last modes.

16. The control system of claim 14, wherein the multiple internal channels of the manifold are configured to provide operability of the actuator control system in any of fail-open, fail-close, fail-last, or fail-last-locked modes.

17. The control system of claim 14 wherein the closures are plugs.

18. A pneumatic manifold connectable to a directional valve operable to move the actuator of a valve actuator control system, the manifold comprising:
a unitary body having multiple internal channels, each with a manifold inlet port and a manifold outlet port;
the manifold being connectable to the directional valve in alternative connections such that the manifold outlet port and manifold inlet port of one active internal channel communicate with the valve inlet port and valve outlet port, respectively, of the pneumatic directional valve;
the multiple internal channels of the manifold being configured to provide operability of the actuator control system in at least a plurality of fail modes.

19. The pneumatic manifold of claim 18, wherein the multiple internal channels of the manifold are configured to provide operability of the actuator control system in any of fail-open, fail-close, or fail-last modes.

20. The pneumatic manifold of claim 18, wherein the multiple internal channels of the manifold are configured to provide operability of the actuator control system in any of fail-open, fail-close, fail-last, or fail-last-locked modes.
